(19) United States
(12) Patent Application Publication
(10) Pub. No.: US 2010/0188265 A1
(43) Pub. Date: Jul. 29, 2010

(54) Network Providing Vehicles with Improved Traffic Status Information

(76) Inventors: Lawrence W. Hill, Eastham, MA (US); Milt Baker, Ann Arbor, MI (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/692,168

(22) Filed: Jan. 22, 2010

Related U.S. Application Data
(60) Provisional application No. 61/146,714, filed on Jan. 23, 2009.

(51) Int. Cl. G08G 1/09

(52) U.S. Cl. 340/905

(57) ABSTRACT

A vehicle communication network provides information about traffic conditions in a local area on a near real time basis. An RF transceiver in a vehicle communicates with other transceivers in other vehicles to relay traffic condition related information. The traffic information can be provided to local vehicles equipped with transceivers, or roadside devices that participate in the communication network. The traffic information is derived from data that may include time, position, velocity, acceleration or other information related to traffic flow. The data can be derived from a GPS, accelerometer or other devices that are typically prevalent in automobiles, whether as standalone units or integrated into the automobile. The transceivers can implement an emergency messaging construct to permit rapid dissemination of traffic information that may be derived from collisions, slowdowns, congestion or other traffic conditions that may prompt drivers to slowdown or otherwise increase vehicle spacing. The vehicle network can be implemented using add-on equipment in conjunction with PNDs or smart cellular telephones, or as a standalone device that is optionally integrated into a PND or vehicle.

### STATEMENT REGARDING FEDERALLY SPONSORED RESEARCH OR DEVELOPMENT

(Not Applicable)

### BACKGROUND OF THE INVENTION

1. Field of the Invention

This invention relates to the use of a peer-to-peer network among automotive vehicles to share information on traffic conditions, and to share such information with broadcast networks which provide traffic status to a broader audience.

2. Description of Related Art

In the study of traffic flow, roadway capacity, including vehicle throughput, is an important factor that is impacted by the incidence of shock waves that propagate through the traffic flow as a result of slowdowns due to traffic events such as congestion, accidents and so forth.

Shock waves tend to reduce roadway throughput, and can result in rear end collisions when drivers rapidly decelerate.

Some types of automobile control systems can reduce the effects of shock waves in roadway throughput. For example, active cruise control (ACC) uses radar or lidar to sense when a leading vehicle is decelerating to maintain a separation space by slowing the following vehicle. Cooperative active cruise control (CACC) permits vehicles to communicate with each other using an RF link so that vehicles can maintain a general speed, and decelerate or accelerate when vehicles participating in the communication are determined to be respectively decelerating or accelerating. There are a number of challenges in practical implementations of ACC or CACC, including a level of deployment for systems in vehicles to produce material results. In addition, there is a significant lag time between when vehicle systems can be implemented based on a multi-year design cycle time for automobiles. Furthermore, vehicles tend to have approximately a ten year life cycle so that a length of time until implementation of systems such as ACC or CACC to have a practical impact can be extensive. Moreover, the cost associated with implementing ACC or CACC can be significant for automobile manufacturers.

The Department of Transportation has provided funding for development of vehicle to vehicle (V2V) and vehicle to infrastructure (V2I) type communications to permit inter-vehicle communication. However, a standard for communication using V2V or V2I frameworks is still unresolved, so that the advent of deployable hardware to implement such systems is uncertain. Moreover, the above-noted difficulties with respect to cost and deployment of ACC and CACC systems are also applicable to V2V and V2I systems. The implementation of V2I systems relies upon roadside infrastructure which raises cost and practicality issues when implementation of vehicle systems remain uncertain. Accordingly, it is difficult to implement the above-described systems with a sufficient degree of certainty that is practical and cost effective until further developments are realized.

WO 2007/133264 and U.S. application Ser. No. 12/086,161 describe a system for communication between vehicles and for determining the positions of such vehicles relative to one another. Further relevant prior art is cited in these applications.

Separately, current Personal Navigation Devices (PNDs) use a Global Positioning System (GPS) to provide a driver with information about position relative to a road map, and further include the ability to receive information about the status of traffic ahead of the driver on the intended route. This information is received from an FM subcarrier broadcast, cellular telephone data transmissions, or other means. However, the information so received is derived from a data base whose input is observations by traffic helicopters, interested individuals who call in reports of incidents on their cell phones, and other sources. As a result, the traffic information, though often useful, is not always current, and would be much more valuable if it were truly real-time.

Currently available information is good for major incidents but is often found lacking in timeliness for localized traffic jams that impede traffic flow. Accordingly, a means of providing immediate information about traffic incidents which are delaying traffic to those vehicles which are approaching the site of the incident is highly desirable, and would dramatically increase the value of existing traffic information services. The invention described below provides such improvement.

### BRIEF SUMMARY OF THE INVENTION

In accordance with the disclosed system and method, an RF transceiver in a vehicle communicates with other transceivers in other vehicles to relay traffic related information. The traffic related information can be provided to local vehicles equipped with transceivers, or roadside devices that participate in the communication network. The traffic related information refers to, and/or is derived from, data that may include time, position, velocity, acceleration or other information related to traffic flow. The data can be derived from a GPS, accelerometer or other devices that are typically prevalent in automobiles, whether as standalone units or integrated into the automobile. The transceivers can implement an emergency messaging construct to permit rapid dissemination of traffic information that may be derived from collisions, slowdowns, congestion or other traffic conditions that may prompt drivers to slowdown or otherwise increase vehicle spacing.

Present global position system (GPS) devices are available for vehicles in the form of a personal navigation device (PND). A PND typically communicates with a variety of systems, including satellite, FM subcarrier broadcast, cellular telephone transmissions, including data transmissions, Bluetooth radio frequency and/or other types of communication systems. Localized traffic information is often available over an FM radio signal that can be interpreted by the PND to advise the driver of localized traffic conditions. PNDs are often equipped with Bluetooth wireless communication devices for short range communications, such as may be used for hands-free mobile phone communications. Bluetooth is an open wireless short range communication protocol that uses relatively short wavelength radio frequency signals. The presently disclosed system and method implements a local communication network among vehicles and/or roadside stations to relay traffic condition related data. By combining GPS information with available traffic information, the disclosed system and method shares timely traffic information with vehicles in a localized area to provide accurate and timely localized traffic information.

According to one exemplary embodiment, the disclosed system and method are implemented in an add-on device that can be used in conjunction with existent PNDs to reduce implementation costs and avoid costs associated with purchasing a new PND for a vehicle, whether portable or integral with the vehicle. According to another exemplary embodiment, the disclosed system is implemented in a standalone device that includes a dedicated GPS. According to another exemplary embodiment, a smart cellular telephone equipped with a GPS, processor and user interface is used in conjunction with a Bluetooth-connected accelerometer and a local communication network transceiver to implement the present disclosure.

Existing PNDs contain information about where they are, how fast they are moving, and recent history of their location and speeds. In accordance with an exemplary embodiment of the present disclosure, this information is shared with approaching drivers through one or more of the following methods:
1. A local, peer-to-peer RF communications network, through which suitably equipped PND devices broadcast traffic status to vehicles which will shortly arrive at the place being reported;
2. Transfer of such information to real-time traffic data bases for subsequent broadcast, via road-side units which collect information from the network.

The shared information permits other vehicles participating in the peer-to-peer network to have the opportunity to divert to more desirable routes based on relatively current information about traffic conditions on the roadway ahead. Subscribers to a real-time broadcast of traffic data also can benefit from receiving recent information even without any new equipment in their vehicles.

The peer-to-peer radio network between the vehicles may operate using one or more protocols. The network communication relays information about a location to vehicles that are approaching the location, in near real time, so that the approaching vehicles can timely divert to a more favorable route.

With localized communication of traffic information, the disclosed system and method can reduce or eliminate the effects of shockwaves or oscillations in the flow of traffic. In addition, drivers can be notified of local upcoming slowdowns in the roadway to permit the drivers to decelerate in a timely manner to avoid rapid decelerations. By avoiding rapid decelerations in the event of traffic congestion or slowdowns, shockwaves can be reduced or eliminated and the occasions of rear-end collisions can similarly be reduced or eliminated.

### BRIEF DESCRIPTION OF THE SEVERAL VIEWS OF THE DRAWINGS

The present disclosure is described in greater detail below, with reference to the accompanying drawings, in which:

FIG. 1 shows abstracted communications among various elements in accordance with the disclosed system and method;

FIG. 2 illustrates a flow of information among specific vehicles;

FIG. 3 is a block diagram of an exemplary embodiment of the disclosed system and method for a single vehicle;

FIG. 4 is a perspective view of a device according to an exemplary embodiment of the disclosed system and method;

FIG. 5 is a block diagram of another exemplary embodiment of the disclosed system and method; and

FIG. 6 is a block diagram of another exemplary embodiment of the disclosed system and method.

### DETAILED DESCRIPTION OF THE INVENTION

The entire disclosure of U.S. Provisional Application No. 61/146,714, filed Jan. 23, 2009 is hereby incorporated herein by reference.

Personal navigation devices (PNDs) have become widely used in automobiles due to their practical advantages and relatively low cost, for example. PNDs are typically able to communicate through a number of different channels or networks to exchange data and present navigation information to a driver. PNDs are typically equipped with a global positioning systems (GPS) to obtain location and route information for presentation to a driver. A number of PNDs also offer real time traffic information broadcasts to warn drivers of localized slowdowns or traffic jams, and potentially suggest detour routes to avoid traffic congestion.

Some of the data presented through various types of PNDs may be derived from systems that can include roadside sensors, wire loops in roadway pavement, roadway toll information, aircraft observation or data from vehicles obtaining through cellular communication links. The collected data is provided to a database, and then processed using statistical methods and traffic flow models, which may include historical data, and transmitted to PNDs in one or more of a variety of communication channels. The PNDs receiving such information may be enabled based on a subscription service with the information collector and processor.

The information provided to the PNDs may be communicated over an FM subchannel broadcast, satellite radio, cellular data or voice channels, television broadcasts, or any other type of communication channel. Some PND systems are propriety with respect to collected information concerning roadway traffic, so that the collected information is limited by the number of units participating in the proprietary system. In some of these types of proprietary systems, cellular communication is used, which represents an ongoing cost for the user, as well as occasional loss of signal that can occur with cellular data communications. Some of these drawbacks inhibit the usefulness and deployment of such systems for use on a widespread basis.

There continues to be a challenge in presenting a driver of an automobile with current information that permits the driver to make decisions regarding alternate travel routes. For example, in the event of a collision, lane closure or other localized events that may cause traffic congestion, current information regarding such events is typically unavailable to drivers until they experience the slowdown or traffic jam. The opportunity for a driver to detour to an alternate route is typically lost due to the lack of current information, since the driver on a limited access roadway has often passed an exit that would permit them to avoid the traffic jam or slowdown. Accordingly, more current information concerning roadway traffic condition in a localized area is highly desirable, and can be attained by practical implementation of the presently disclosed system and method.

PND devices can provide information about their present location, their speed, and recent history of location and speed. According to an exemplary embodiment of the present disclosure, the information available to the PND device is shared with approaching PND devices. The information can be communicated using a local, peer-to-peer RF communication network, or by providing information to a real time traffic database by roadside units for subsequent broadcast. Drivers approaching a localized area of traffic congestion can take advantage of this information to timely select alternate routes or other action in response to notice of upcoming traffic congestion.

The peer-to-peer RF communication network permits the PND devices in the local area to communicate on both sides of a roadway with traffic typically traveling in opposite directions on each side. PND devices located in vehicles on an opposite side of the roadway from a localized slowdown or congestion can collect traffic information obtained from vehicles experiencing the traffic congestion. This traffic information can be collected, summarized, formatted and/or delivered to vehicles that may be approaching the traffic congestion traveling in an opposite direction from the information collecting vehicles. Alternately, vehicles on the opposite site of the roadway from the traffic congestion, or vehicles that are experiencing traffic congestion, can provide real time traffic information to roadside units for submission to a traffic database, which can then be used to broadcast traffic data to vehicles approaching the traffic congestion.

The vehicles approaching the traffic congestion that use the peer-to-peer network have the opportunity to diverge to better routes based on more current information than is available from traffic information that is slowed due to delays involved in such steps as observation, collection, processing and transmission to a local user.

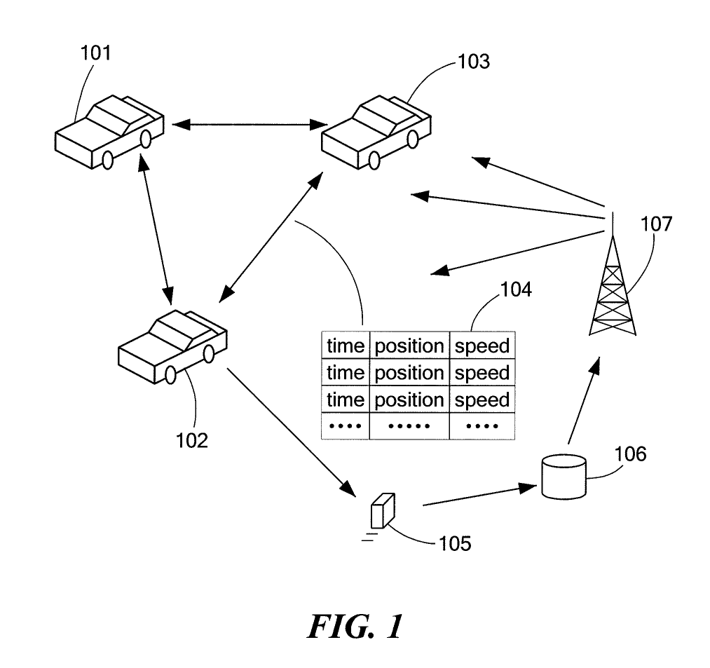

FIG. 1 shows the general elements of the systems implemented in vehicles 101, 102, and 103 to broadcast messages 104 containing recent positions and speeds. The systems store and summarize this information, and later retransmit it for the benefit of drivers approaching the locations where delays are occurring. In addition, the systems implemented in vehicles 101, 102, and 103 may transmit their data periodically to a roadside unit 105, from which the data may be sent to a central data base 106, where the information is merged with that from other sources, and then broadcast via FM subcarrier 107 or other means for the benefit of all vehicles. According to one embodiment, data transmissions from each vehicle participating in the car-to-car network occur about once every two seconds.

According to an exemplary embodiment, the current traffic information provided in accordance with the disclosed system and method may be based on a subscription. The PND receiving the traffic information can be configured to offer warnings, adjust trip duration or suggest alternate routes, for example. Alternately, or in addition, PND manufacturers can adapt their devices to integrate the disclosed system and method and incorporate a subscription service as part of the cost of the PND or an add-on device to the PND. As another alternative, the disclosed system and method can be implemented in a standalone device that includes a dedicated GPS that can provide traffic information. The standalone device, or other devices disclosed herein, can implement the disclosed communication network on a subscription basis or may have the subscription cost incorporated into the purchase price.

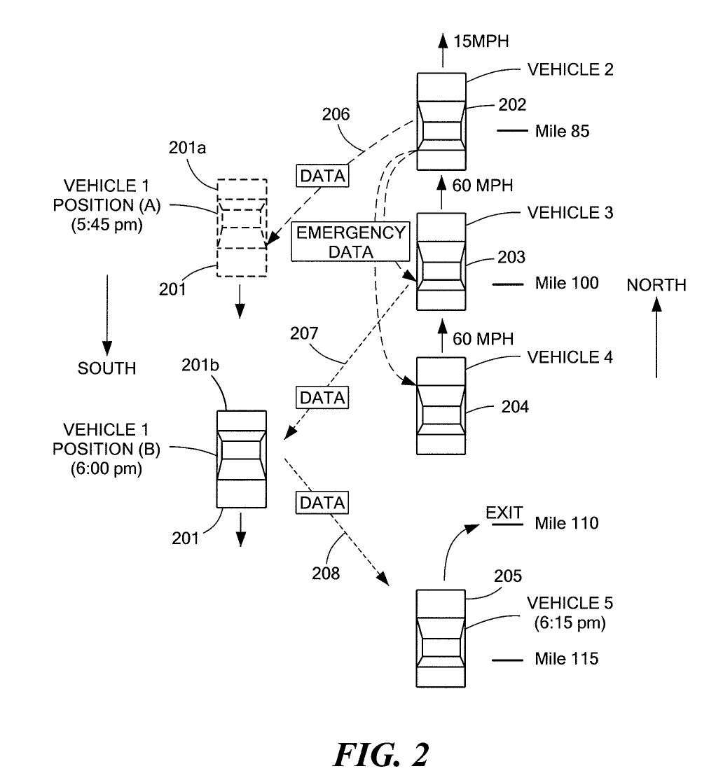

Vehicles with PNDs equipped with an implementation of the disclosed system and method receive timely warnings from other similarly equipped vehicles within the localized traffic area, as well as within the localized communication network area. Referring now to FIG. 2, an illustration of communication between vehicles in accordance with an exemplary embodiment of the disclosed system and method is depicted. The PND devices in the vehicles can broadcast or exchange traffic related information to advise upstream drivers of localized traffic conditions they may be approaching.

FIG. 2 shows a sequence of communications between northbound and southbound vehicles in accordance with an exemplary embodiment. In this example, vehicle 201 is shown in two successive positions 201a and later at 201b, traveling in a southbound direction. Vehicles 202, 203, 204 and 205 are traveling in a northbound direction. Each of vehicles 201-205 can be equipped with a PND that includes a transmitter and receiver for implementing a peer-to-peer communication network. The transmitter and receiver can be provided as an add-on device to the PND, or can be integrated into the PND in accordance with embodiments of the disclosed system and method. Alternately, or in addition, the transmitter and receiver can be implemented in a standalone device that can provide data related to traffic conditions. In this description, when vehicles are described as communicating with each other in accordance with the disclosed system and method, it is understood that the transmitters and receivers, or transceivers, in the vehicles implement the communications and communication network between vehicles.

Vehicles participating in the car-to-car network can receive current traffic information and timely warnings of traffic congestion or slowdowns. Vehicles passing a slow or congested roadway on an opposite side can obtain information from the vehicles involved in the congestion, which information may include time, position, speed, codes, text, identification or other information that may be helpful in determining traffic conditions. In FIG. 2, vehicles 201-205 are each presumed to be capable of participating in the car-to-car network. In the example illustrated in FIG. 2, at 5:45 pm, vehicle 201a receives a message 206 from vehicle 202 indicating a location at mile marker 85, and traveling at 15 mph. At 6:00 pm, vehicle 201b receives a message 207 from vehicle 203 indicating a location at mile marker 100, with a speed of 65 mph. Vehicle 201 proceeds southward, periodically broadcasting the data received from vehicles 202, 203. At 6:15, vehicle 205, located at mile marker 115, receives the information via message 208, deduces a slow-down at mile marker 85, and chooses an alternate route that turns off at mile marker 110, thus avoiding the back-up. As more drivers become aware of the upcoming slowdown or congestion, they can make timely decisions about selecting alternate routes. By potentially reducing the volume of traffic supplied to the slowed or congested roadway, the probability of shock waves and sudden stops can be reduced.

The above-described message routing can be highly useful for accident avoidance. For example, vehicle 202 can transmit the report of a sudden slowdown upon its occurrence, which transmission can be received by vehicles 203 and 204. The transmission can occur on an emergency basis, so that receiving vehicles 203, 204 treat the incoming message with special priority. For example, vehicle 202, upon experiencing a sudden slowdown, can transmit information that may include time, position, speed and a code or identifier that can indicate a special status, such as emergency status. Vehicles 203 and 204 can receive the special status transmission to alert the driver to slowed traffic conditions in the immediate area. The alert permits additional reaction time for the driver and can reduce the possibility of collision.

The PND or other devices that contribute to implementing the disclosed system and method can produce an indication that can alert the driver to the slowed traffic conditions ahead. For example, the indication may be a displayed message, an audio prompt, such as a beep or verbalized message, a tactile prompt such as a vibratory output, or other types of indications that can alert the driver to the upcoming traffic conditions. With the implementation of these measures, drivers can be alerted to upcoming slowdowns or congestion, and increase vehicle spacing, thereby reducing the possibility of a shock wave being formed or reducing the effects of such phenomena.

The V2V and/or V2I capable PNDs may operate using dedicated short range communications (DSRC), a standard for which is still under development. In accordance with the specifications for a DSRC system, the inter-vehicle communications utilize a radio frequency signal with a nominal range of approximately 300 meters. At such a range, a two-lane roadway is estimated to include approximately 40 cars per lane in the communication network in heavily congested traffic. This estimate, using approximately 15 meters per car, can be extended to eight lanes of traffic, with a result of approximately 320 vehicles, potentially participating in the inter-vehicle communication network.

Assuming a throughput of approximately 6 Mbps, with a message of about 100 bytes being transmitted about every two seconds, the channel loading for nominal communications is about 2.7 milliseconds. This type of communication and channel loading can avoid impeding emergency messages from being sent or received. The two second interval can be designated on the assumption that vehicles traveling at approximately 30 meters per second can transmit and receive messages in the inter-vehicle communication network, given that vehicles may be traveling in opposite directions and a 300 meter range for transmitted and received messages. Communication channels for the PNDs can be arranged for the transmission of a routine status message until the expiration of a time period after the last such routine status message. In this way, emergency status messages can have a low latency to permit reporting of rapid deceleration in under 1 millisecond, even under maximum communication load conditions.

According to an exemplary embodiment of the disclosed system and method, an additional or alternative message routing may be employed, in which traffic data is simply forwarded from car to car back down the line of vehicles moving in one direction, with the message transfer happening in the direction opposite to their motion. In FIG. 2, for example, vehicle 202 would transmit, vehicle 203 would repeat, and vehicle 204 would repeat for vehicles behind it, and so on. In this way, the rapid propagation of traffic information can continue down a roadway in a direction opposite to that of vehicle travel, with vehicles relaying the traffic information within their local area. As the traffic information propagates down the roadway, drivers that have an opportunity to select an alternate route to avoid the upcoming slowdown can make a decision on the route to be taken.

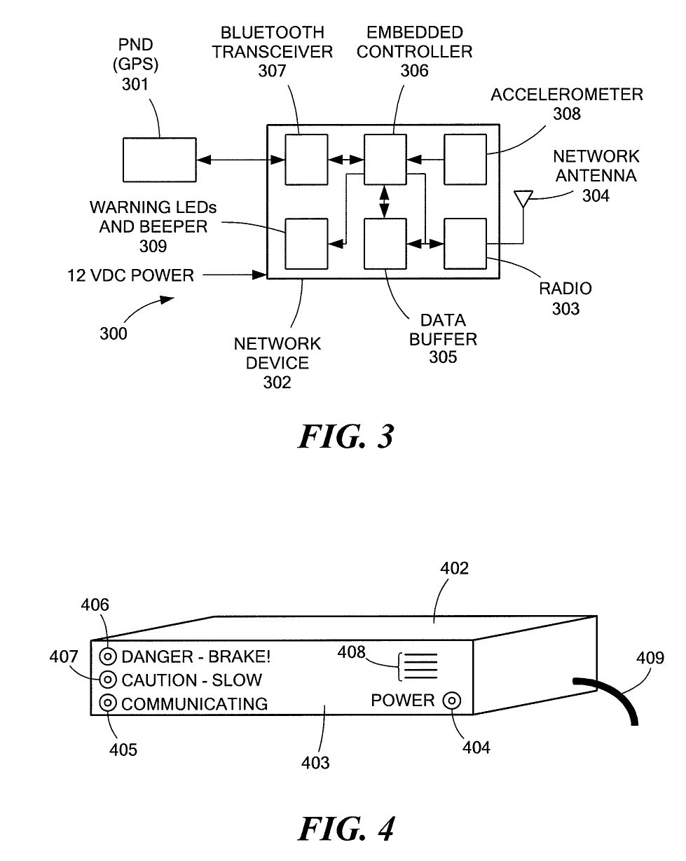

FIG. 3 shows elements of on-board equipment 300 in a participating vehicle. On-board equipment 300 includes a standard PND 301, which typically is equipped with a GPS, a display, optionally a receiver for FM subcarrier traffic broadcasts, and Bluetooth type local RF communications. A network device 302 implements the system and/or method of the present disclosure and is composed of various components described below.

In accordance with the embodiment of on-board equipment 300 illustrated in FIG. 3, network device 302 can be implemented separately from PND 301, and exchange communication messages therebetween with a Bluetooth transceiver 307. Bluetooth transceiver 307 permits exchange of communication messages with PND 301 to obtain periodic updates of speed, position, or other useful information, such as more rapid updates in the event of a rapid deceleration. Bluetooth transceiver 307 exchanges information with embedded controller 306, which may be implemented as a processor to provide control for network device 302.

Network device 302 also includes a radio transceiver 303, which can send and receive radio frequency messages using network antenna 304. Radio transceiver 303 and network antenna 304 are used to participate in the local area network. The network can be implemented on a peer-to-peer or other topology, including those in accordance with evolving protocol standards, to exchange traffic information with other vehicles. Radio transceiver 303 is also coupled to a data buffer 305 which can be used for data storage and retrieval. Data buffer 305 can receive data from radio transceiver 303 derived from received network messages. Data buffer 305 can also provide data to radio transceiver 303 for transmission of network messages.

Embedded controller 306 is coupled to data buffer 305 and radio 303 to control messaging and data transfer in the local vehicle network. For example, embedded controller 306 can process data stored in data buffer 305 to format messages that are also stored in data buffer 305 for transmission through radio transceiver 303. Embedded controller 306 can also implement algorithms to analyze data from various sources, including data buffer 305, Bluetooth transceiver 307, or an accelerometer 308. For example, embedded controller 306 can process data and/or provide outputs or control signals to other components to implement a communication protocol in the local traffic network. Embedded controller 306 can manage communications among data buffer 305, radio transceiver 303 and Bluetooth transceiver 307. Embedded controller 306 is capable of managing communication messages to participate in several different communication interfaces, which interfaces may include Bluetooth transceiver 307 or radio transceiver 303. Data buffer 305 can be used to store and retrieve recently received messages from Bluetooth transceiver 307 or radio transceiver 303. The received messages can be summarized, reformatted and retransmitted for use at the different communication interfaces. Bluetooth transceiver 307 permits the exchange of data between PND 301 and network device 302.

PND 301 typically includes a Bluetooth transceiver (not shown) that can exchange information with network device 302 using Bluetooth transceiver 307. PND 301 may be modified to provide periodic updates of speed, position, or other information through programming that may be applied to internal firmware. PND 301 can also be configured to provide more frequent updates in the event a rapid deceleration is detected. For example, a PND may filter position data to improve accuracy, which may result in a relatively long period of time to report a change in speed. PND 301 can be altered to increase a response time to report a change in speed upon detection of a rapid deceleration. For example, position data filtering used to improve accuracy can be modified to decrease reporting time upon the detection upon a change in speed. The increased reporting frequency can be used to notify other vehicles in the local communication network about sudden decelerations.

Network device 302 also includes an accelerometer 308, which can be an inexpensive MEMS-based accelerometer, for example. Accelerometer 308 can be used to sense rapid deceleration, which may occur with hard braking or in the event of a collision. Upon detection of rapid deceleration fitting a particular profile or exceeding a certain threshold, for example, accelerometer 308 can signal embedded controller 306 to prompt an immediate emergency message. Upon being triggered by accelerometer 308, embedded controller 306 can produce an immediate emergency message and take steps to provide emergency communication messages at the communication interfaces. For example, embedded controller 306 can signal an increased frequency for updates by PND 301, using Bluetooth transceiver 301, as well as increased frequency transmissions in the local communication network using radio transceiver 303. Accelerometer 308 can therefore provide a faster response in the event of a rapid deceleration than might be the case by utilizing information from PND 301.

Network device 302 also includes output devices to signal a driver concerning traffic information or events. Output devices 309 can provide visual, audible, or tactile (such as vibratory) outputs to signal the driver concerning events such as traffic congestion, rapid deceleration occurring locally or other local communication that may be derived from the local communication network. For example, in the event a rapid local deceleration is detected, output device 309 can provide a flashing light or audible warning tone or vibrational indication of upcoming traffic congestion, rapid deceleration, or other events in the local area. Network device 302, PND 301 and/or on-board equipment 300 may operate on a 12 volt DC power supply provided by the automobile, internal battery power, or both. The power supply can be used to power the electronics used to operate on-board equipment 300, including output devices 309.

Referring now to FIG. 4, an exemplary physical package 402 is illustrated that can house network device 302. When package 402 is used to house network device 302, PND 301 may be used as an operator or user interface to provide a display, audible alerts or voice messages. Alternately, or in addition, package 402 may provide operator or user interface functions in conjunction with, or separately from PND 301.

Package 402 can also house a standalone implementation of the disclosed system and method, such as by including an internal GPS, accelerometer or other components used to obtain traffic related information. It should be understood that package 402 can provide an operator or user interface independent of the implementation of the disclosed system and method.

A front panel 403 includes various visual indicators such as LEDs that can apprise the driver of various information concerning local traffic conditions. A power indicator 404 can be a green LED, that when lit can indicate power being provided to package 402. Another visual indicator 405 can be implemented as a green LED that turns on to indicate messages being communicated from or to other network devices 302. A visual indicator 406 can be implemented as a red LED that, when lit, indicates a rapid deceleration in a local area ahead in the roadway to inform the driver to brake to avoid a potentially dangerous situation. A visual indicator 407 may be implemented as a yellow LED that, when lit, advises the driver of an upcoming slowdown or congestion to give the driver a chance to slow the vehicle. Alternately, or in addition, visual indicators may be provided that provide an indication of traffic conditions at different upcoming intervals, such as 5, 10 or 15 miles ahead.

Indicators 406, 407 can be turned on and off to provide a flashing indication of danger or caution to the driver. The rate at which indicators 406 and 407 are turned on and off can be modified to provide further information to the driver, such as a rapid flashing frequency to indicate a greater urgency, and a slower flashing frequency to indicate less urgency.

Package 402 also includes a speaker 408 that can be utilized to provide an audible alarm. Various types of alarms can be used to indicate different situations, including the situations identified by indicators 406, 407. In addition, speaker 408 may be used to provide voice information, which may be in the form of a recorded or synthesized voice. Network device 302 may be configured to provide announcements of traffic delays, alternate route suggestions or other voice information, which may be made available from PND 301. Speaker 408 may also be used to provide voice output to implement warnings or suggestions such as “slow down” or “stop ahead.” Package 402 may be supplied power through a power cord 409, which may be connected to the automobile 12 volt DC power.

Referring again to FIG. 3, PND 301 typically has interfaces to permit connection with computing devices, such as personal computers, to permit downloads or updates to software, firmware or other configuration data. For example, a PC can typically be connected to a network such as the Internet though which installation programs or data can be downloaded or installed to a connected device, such as PND 301. Other connections or methods are readily available for updating the configuration or updating of PND 301. Using such an update process, PND 301 can be configured to support data communication through a Bluetooth transceiver (not shown) to permit data to be exchanged with network device 302. PND 301 can optionally be provided from a manufacturer with settings and configuration being arranged to communicate with network device 302, as well as to permit updates to PND 301, as discussed above. According to another exemplary embodiment, the components of network device 302 can be integrated into PND 301 to implement the disclosed system and method in a single physical package.

The radio protocol used to communicate between vehicles can be implemented according to any particular standard or recommendation. For example, the radio protocol may be a DSRC protocol based on IEEE 802.11p, or any other protocol that has gained wide acceptance for use in local area communications between automobiles, especially automobiles moving at highway speeds.

In the case of a DSRC protocol, a short message is broadcast on an emergency channel when accelerometer 308 senses deceleration, such as a predetermined deceleration. If the accelerometer has a filter delay of 1 millisecond, and a channel access delay of about 0.5 milliseconds is experienced in outputting a communication network message with a message propagation delay of about 0.1 milliseconds, following vehicles can receive emergency warnings within 1.6 milliseconds.

The above time frame is significantly smaller than that involved in the visual perception of the driver with respect to observing brake lights on the vehicle immediately to the front. The driver perception time interval may be increased by the fact that intervening drivers between localized slowdowns or congestion and a given driver may sequentially apply their brakes to illuminate their brake lights, factoring in human reaction time of about 0.75 to about 1.5 seconds. Accordingly, based on driver perception, the following distances may be too small to permit a given driver to react appropriately to congestion further up the road, based on the observation of just the vehicle immediately ahead.

The immediate warning provided by network device 302 can be received by all vehicles within a nominal range of 300 meters. With the receipt of the immediate warning or messages indicating rapidly decelerating vehicles ahead, drivers have time to begin slowing their vehicle, without necessarily having to slam on their brakes. With this type of immediate warning that permits drivers to react to traffic conditions in a more timely manner, a roadway traffic shockwave is less likely to form. In addition, the vehicles that are decelerating as a result of being warned of upcoming slowdowns can provide or relay messages to following vehicles concerning the decelerating vehicles to their front. The audible, visual, or tactile warnings provided to drivers in accordance with the disclosed system and method permit the drivers to react sooner to an event related to traffic conditions than might otherwise be possible.

If a number of vehicles on the roadway are equipped with a device in accordance with the disclosed system and method, the chance of collision or formation of a shockwave as a result of a slowdown is greatly reduced. In addition, with the widespread adoption of the disclosed system and method, vehicles can be configured to permit automatic braking to provide an even more rapid response to traffic conditions and the avoidance of collisions or formation of shockwaves.

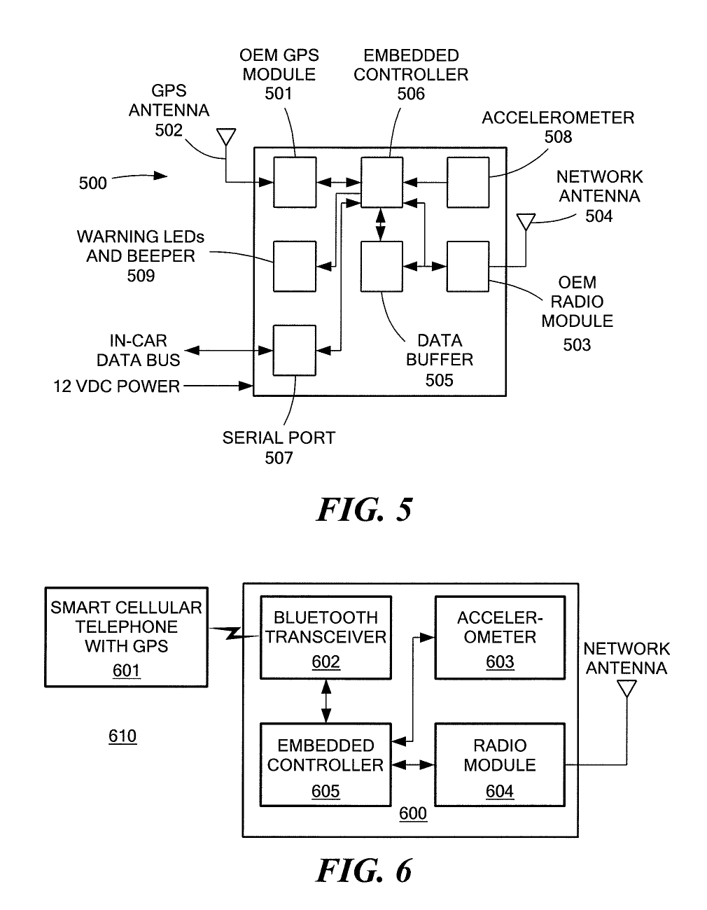

Referring to FIG. 5, an exemplary embodiment of a network device 500 is illustrated. Network device 500 has a radio transceiver 503 that uses a network antenna 504. Radio transceiver 503 can be implemented as a modular 900 MHz ISM band radio transceiver, commercial modules of which are widely available at low cost. Radio transceiver 503 may also be implemented as a DSRC transceiver that employs a standard or can employ an evolving standard. Network device 500 also includes a GPS module 501 that is connected to a GPS antenna 502 to receive and process GPS data supplied to an embedded controller 506. GPS module 501 can provide navigation, including position, speed, time and other information related to navigation. GPS module 501 can be configured to report the various data desired in a given format to permit increased processing efficiency.

Network device 500 also includes a serial port 507 that can be used to connect network device 500 to another computing device, such as a PC. Serial port 507 may be used generally to connect network device 500 to an external device, or to an interface to an automobile control network such as a CAN (Controller Area Network) bus, to permit closed loop adaptive cruise control or other safety related functions, for example. Serial port 507 is coupled to embedded controller 506 to permit exchange of data with devices that are external to network device 500. For example, data derived from the various components of network device 500 can be transmitted to an external device through serial port 507 under the control of embedded controller 506. In addition, embedded controller 506 can control or configure the various connected components of network device 500 based on data received through serial port 507 from an externally connected device. In a like manner, embedded controller 506 can be programmed or updated as well. The remaining components of network device 500 illustrated in FIG. 5 are similar to the components illustrated in FIG. 3, which are described in detail above.

In accordance with the disclosed system and method, existing PNDs can be used with modifications to the software programming or firmware without requiring additional or new hardware. Following current practice, such modifications can be downloaded to the devices via the Internet by the device owners. The disclosed system and method can take advantage of already existing systems to implement a traffic information system that can operate on a local area, as well as provide information on a wide area basis through existing communication networks. In addition, the system and method of the present disclosure can be implemented as a standalone device provided to a vehicle. Because of the ease of deployment, the advantages of the disclosed system and method can be realized more rapidly and with less expense than other known or proposed systems. In addition, the inter-vehicle communication network can be used by traffic signals and other roadway components through vehicle to roadside (V2R) communications. For example, the inter-vehicle communication network can be used to transmit traffic signal changes for approaching vehicles, to trigger messages to be displayed on roadway electronic signs and otherwise provide information that can contribute to improving roadway conditions and traffic flow. Some of the advantages that can result include the reduction of shockwave generation and propagation, rear end collisions and the delays associated with those, effectively increased road capacity through smoother traffic flow, which also results in fuel savings and pollution reduction as well as time savings for commuters. The approach used in the disclosed system and method can provide latency on the order of milliseconds and provide real time traffic data that may be used with other types of active systems such as ACC or CACC.

The software programming or firmware provided in the disclosed system and method such as may be included in embedded controller 306 or 506, can be customized for the device. For example, the operating code may include a set of interrupt handlers to manage the communication and input with various serial ports and accelerometer input. The operating code can be implemented based on a state machine executive program that can handle task interaction associated with various events that can occur during operation of the disclosed system and method. For example, the state machine can address and manage the receipt of radio messages that indicate a visual prompt should be activated. In addition, receipt of accelerometer input that indicates an emergency radio transmission should be generated can be implemented with the state machine. A time-based interrogation of a GPS module, whether integral or external, can also be implemented with the operating code. Routine radio messages are also generated to the network along with the generation of event log data that can be used for test purposes. The operating code may also include run-time system diagnostics and logging of RF performance data. For example, the time lag from the local sensing of a trigger caused by sudden deceleration that is detected by the accelerometer until recognition of the event in other vehicles can be measured using an internal clock that can be implemented in embedded controller 306 or 506. It is further contemplated that the disclosed system and method may be used with, or incorporated into, hard wired ACC or CACC systems installed in vehicles.

The radio protocol may be a DSRC (Dedicated Short Range Communications) device, of the sort now being developed by the auto industry for toll collection, safety alerts, and other purposes. It may be the evolving IEEE 802.11p protocol intended for this same purpose, or it may be the protocol described in patent application WO 2007/133264, or an evolution thereof. It may also be any other protocol which gains wide deployment in automobiles and is suitable for local communications among vehicles moving at highway speeds.

Referring to FIG. 6, another exemplary embodiment of the disclosed system and method is illustrated as a configuration 610. Configuration 610 includes a network device 600 and a smart cellular telephone 601. Telephone 601 can be equipped with a GPS, a Bluetooth interface and a user interface that permits operator or user interaction, such as via a display, speaker, microphone, keypad and/or other input/output mechanisms. Configuration 610 is similar to on-board equipment 300, with telephone 601 taking the place of PND 301. Telephone 601 integrates a user interface, GPS functionality and access to a cellular network for reporting traffic events to a data base accessible to other similarly equipped vehicles.

Telephone 601 can also be used with network device 600 in accordance with the disclosed system and method via a Bluetooth or functionally equivalent interface 602. Network device 600 can include an accelerometer 603 and a vehicle-to-vehicle radio module 604. An embedded controller 605 provides control for network device 600, and may include a data buffer for use with interface 602, accelerometer 603 and/or radio module 604. Configuration 610 permits software, such as might be executed by embedded controller 306 in network device 302 (FIG. 3), to instead run as an after-market application in telephone 601. In such an instance, embedded controller 605 may perform data management and coordination tasks within network device 600 rather than execute standalone application software. With configuration 610, local ordinary or emergency traffic related information is communicated by the DSRC network in real time to permit timely actions by nearby drivers. In addition, the traffic related information can be made available to a traffic data base via the cellular link in telephone 601, for use in non-real time other applications or users.

Other embodiments are possible. For example:
1. PNDs may be manufactured which include the capabilities of radio transceiver, data buffering and format conversion, and Bluetooth communication as described in FIG. 3 to implement the disclosed system and method;
2. PNDs or smart cellular telephones with such capability may be incorporated into new automobiles as original equipment;
3. The system may be combined with a speed radar detector, so that members of the peer-to-peer network receive real-time information about the location of speed traps. This could be either via the Bluetooth connection, or by incorporating the network components into the radar detector;
4. The Bluetooth interface might also transmit traffic status via a cell-phone in the vehicle to a traffic data base, as an alternative to the road-side unit; or
5. Advanced Driver Assistance Systems (ADAS) used for safety, contain GPS information which along with the disclosed system and method can be used for the benefit of peer-to-peer traffic in ADAS equipped vehicles.

It should be emphasized that the above-described embodiments of the present invention are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed:

1. An apparatus in a vehicle for implementing a communication network with at least two nodes for sharing information related to local traffic conditions, comprising:
a radio communication interface for connecting to the communication network;
a data source associated with the vehicle for providing information related to vehicle operation;
a processor communicatively coupled to the data source and the radio communication interface and operable to transfer information derived from the data source to the radio communication interface for transmission to another node in the communication network; and
the processor being further operable to process information received at the radio communication interface and generate a signal related to local traffic conditions based on the received information.

2. The apparatus according to claim 1, further comprising a user interface communicatively coupled to the processor for receiving the signal and presenting a related indication of local traffic conditions to a user in the vehicle.

3. The apparatus according to claim 1, wherein the communication network comprises a peer-to-peer communication network.

4. The apparatus according to claim 1, further comprising a data buffer communicatively coupled to the communication interface and the processor for storing information.

5. The apparatus according to claim 2, wherein the indication presentable by the user interface includes one or more of a visual, audio or tactile indication.

6. The apparatus according to claim 1, wherein the radio communication interface is operable to implement a dedicated short range communication protocol for connecting to the communication network.

7. The apparatus according to claim 1, wherein the data source comprises one or more of a personal navigation device, a smart cellular telephone, a global positioning system, an accelerometer, a storage memory or a radar detector.

8. The apparatus according to claim 1, further comprising one or more of a short range wireless communication interface or a cellular communication interface for communicatively coupling the processor to the data source.

9. The apparatus according to claim 1, wherein the radio communication interface is operable to communicate with a remote database.

10. The apparatus according to claim 1, wherein the data source can provide one or more of time, position, velocity, acceleration, coded or text data.

11. The apparatus according to claim 1, wherein the radio communication interface is operable with a range of about 300 m.

12. The apparatus according to claim 1, wherein the processor is further operable to initiate an emergency message for transmission to other nodes in the communication network.

13. The apparatus according to claim 2, further comprising one or more of a short range wireless communication interface or a cellular communication interface for communicatively coupling the processor to the user interface.

14. A method for sharing information about local traffic conditions using a vehicle communication network, comprising:
obtaining data representative of operation of a vehicle associated with a network node;
processing the data to produce formatted data for transmission in the vehicle communication network; and
transmitting the formatted data in the vehicle communication network.

15. The method according to claim 14, further comprising:
receiving formatted data representative of operation of another vehicle associated with another network node; and
generating a signal related to local traffic conditions based on the formatted data.

16. The method according to claim 15, further comprising:
receiving the signal at a user interface; and
presenting a related indication of local traffic conditions using the user interface based on the received signal.

17. The method according to claim 16, wherein presenting the related indication further comprises utilizing one or more of a visual, audio or tactile indication.

18. The method according to claim 14, further comprising implementing the vehicle communication network using a dedicated short range communication protocol.

19. The method according to claim 14, wherein obtaining data further comprises accessing one or more of a personal navigation device, a smart cellular telephone, a global positioning system, an accelerometer, a storage memory or a radar detector.

20. The method according to claim 14, wherein obtaining data further comprises implementing one or more of a short-range wireless communication interface or a cellular communication interface.

21. The method according to claim 14, wherein obtaining data further comprises obtaining one or more of time, position, velocity, acceleration, coded or text data.

22. The method according to claim 14, further comprising transmitting an emergency message in the vehicle communication network.

23. The apparatus according to claim 16, further comprising receiving the signal via one or more of a short range wireless communication interface or a cellular communication interface.
